(19) United States
(12) Patent Application Publication
(10) Pub. No.: US 2008/0146773 A1
(43) Pub. Date: Jun. 19, 2008

(54) Nucleophilic Acyl Substitution-based Polymerization Catalyzed by Mononuclear Oxometallic Complexes

(75) Inventor: Chien-Tien Chen, Taipei (TW)

Correspondence Address: WPAT, PC, 7225 BEVERLY ST., ANNANDALE, VA, 22003, US

(73) Assignee: NATIONAL TAIWAN NORMAL UNIVERSITY, Taipei (TW)

(21) Appl. No.: 11/950,455

(22) Filed: Dec. 5, 2007

Related U.S. Application Data
(63) Continuation-in-part of application No. 11/459,003, filed on Jul. 20, 2006.

(30) Foreign Application Priority Data
Jul. 22, 2005 (TW) 094124840

(51) Int. Cl. C08G 69/04; C08G 63/68; C08G 67/00; C08G 75/00

(52) U.S. Cl. 528/332; 528/364; 528/271; 528/391; 528/395

(57) ABSTRACT

The present invention discloses a nucleophilic acyl substitution-based polymerization catalyzed by mononuclear oxometallic complexes. In the first place, the first monomers with a plurality of carboxyl groups, and the second monomers with a plurality of protic nucleophilic groups are provided, wherein the protic nucleophilic groups comprise hydroxyl, amine, or thiol group. Next, catalyzed by the mentioned mononuclear oxometallic complex, the first monomers and the second monomers are polymerized into the designed polymer. On the other hand, this invention discloses another nucleophilic acyl substitution-based polymerization catalyzed by mononuclear oxometallic complexes. In the first place, monomers with at least one carboxyl (phosphonyl) group and at least one masked protic nucleophilic group are provided. Then, monomers are polymerized into the designed polymer, catalyzed by the mentioned mononuclear oxometallic complexes.

### CROSS REFERENCE TO RELATED APPLICATIONS

This application is a continuation in part of applicant's earlier application Ser. No. 11/459,003, filed Jul. 20, 2006.

### BACKGROUND OF THE INVENTION

1. Field of the Invention

The present invention is generally related to a method of catalyzed nucleophilic acyl substitution with polymerization, and more particularly to a method of nucleophilic acyl substitution-based polymerization catalyzed by mononuclear oxometallic complexes.

2. Description of the Prior Art

Direct esterification reactions are extensively applied in the industry. In general, ester-based commercial products comprise varnishes, solvents, essence, elasticizers, resin curing agents, polymer materials for packaging, such as polybutylene terephthalate (PBT), polyethylene naphthalene dicarboxylate (PEN), polyethylene terephthalate (PET), and medicine synthetic intermediates. Conventional esterification reactions use acids and excess amount of alcohols as the raw materials in the presence of Brønsted acid catalysts, such as sulfuric acid, boric acid, or hydrochloric acid to accelerate the esterification reactions. However, it has the disadvantages of dealing with subsequent waste water and the process equipments need anti-corrosive treatment due to the addition of strong acids. More critically, the alcohols can not have acid-sensitive functional groups like tetrahydropyranyl ethers, silyl ethers, and acetonides. In addition, it has been widely reported that Sn(II) and Sn (IV) species can be used to catalyze the esterification reactions. Although the catalytic performance is satisfactory, they are highly neuro-toxic which result in potential damages to operator's health and to the environment.

In addition, trans-esterification reactions play an important role in synthetic organic chemistry. Trans-esterification reactions can be applied not only in the synthesis of various esters but also in the industrial processes of dyes, suntan lotions (UV absorbers), preservatives, and etc. In general, the catalysts for trans-esterification reactions comprise (1) Brønsted acids (H₃PO₄, H₂SO₄, HCl) and organic acid (p-TSA); (2) alkaline oxides (LiOR, NaOR, and KOR) or alkaline earth oxides (ROMgBr); (3) Lewis bases (4-N,N-dimethylaminopyridine, DBU, imidazolinium carbenes); (4) Lewis acids (BX₃, AlCl₃, Al(OR)₃); (5) tin-containing compounds (Bu₃SnOR, SnCl₂, Sn(O₂CR)₂, Bu₂SnO) palladium salts, and titanium alkoxide/titanium chloride (Ti(OR)₄, Ti(OR)₂(acac)₂/TiCl₄). Although the above catalytic systems can provide high conversion rate, the following essential problems remain to be resolved: (1) excess amount of alcohols or esters needed; (2) high dosages in catalyst loadings; (3) catalyst by-products are not water-soluble and toxic to the environment; (4) limited functional group compatibility.

In light of the above-mentioned problems, a new neutral, water-tolerant catalyst is still in great demand to fulfill the requirements of non-corrosive or even neutral property, low toxicity, environmental protection. This remains an important research aspect in the industrial practical applications.

### SUMMARY OF THE INVENTION

In view of the above background and to fulfill the requirements of the green industry, a new method of nucleophilic acyl substitution-based polymerization catalyzed by mononuclear oxometallic complexes is invented.

One subject of the present invention is to provide a new method of nucleophilic acyl substitution-based polymerization catalyzed by mononuclear oxometallic complexes. The polymerization method can be readily operated under mild reaction conditions. Besides, in some polymer systems, polymeric products are formed as solid precipitate even in reaction solvent, which can be settling-separated directly. In addition, the mononuclear oxometallic complexes provided by the present invention display the characteristics of long-term activity, and high water and air compatibilities so that the polymerizations may proceed in the above-mentioned polymer systems as long as the monomers are continuously provided. Thus, the production cost is significantly reduced. Furthermore, the mononuclear oxometallic complexes can be recycled after the nucleophilic acyl substitution reaction and the recycled catalysts still maintain excellent catalytic function. Therefore, the method according to the present invention has not only the economic advantages for industrial applications but also environmental friendliness.

Accordingly, the present invention discloses a method of nucleophilic acyl substitution-based polymerization catalyzed by mononuclear oxometallic complexes. At first, the first monomer possessing carboxyl or ester groups and the second monomer bearing protic nucleophilic groups are provided. The protic nucleophilic groups comprise hydroxyl, amine group, or thiol groups. Next, the polymerization between the first monomer and the second monomer catalyzed by a given mononuclear oxometallic complex is carried out at elevated temperature (from 60 to 300° C.) to form polymers. On the other hand, the present invention also discloses another method of nucleophilic acyl substitution-based polymerization catalyzed by mononuclear oxometallic complexes. At first, a monomer with at least one carboxyl group or one ester (phosphonates) group and at least one masked protic nucleophilic group is provided. Next, the polymerization of the monomer with each other catalyzed by a given mononuclear oxometallic complex is carried out to form polymers.

### DESCRIPTION OF THE PREFERRED EMBODIMENTS

What is probed into the invention is a method of nucleophilic acyl substitution-based polymerization catalyzed by mononuclear oxometallic complexes. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In the first embodiment of the present invention, a method of nucleophilic acyl substitution-based polymerization catalyzed by mononuclear oxometallic complexes is provided. At first, the first monomer with a plurality of carboxyl or ester groups and the second monomer with a plurality of protic nucleophilic groups are provided. The protic nucleophilic groups comprise hydroxyl, amine, or thiol group. Next, the polymerization between the first monomer and the second monomer catalyzed by a given mononuclear oxometallic complex is carried out. For example, a preferred reaction equation in this embodiment is shown in the following. The first monomer has two carboxyl groups or two ester groups (R²OOC—R¹—COO—R²; R² is H or C₁-C₅ alkyl group). The second monomer has two protic nucleophilic groups (HA-R³-AH; A stands for O, S, or N). The mononuclear oxometallic complex M=OₘL¹_{y}L²_{z} with at least one M=O double bond is used to catalyze the polymerization between the first monomer and the second monomer to form polymers.

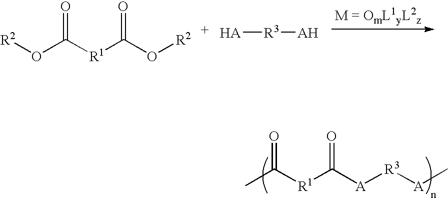

The subscript-m and y of the mononuclear oxometallic complex are integer greater than or equal to 1 and z is an integer greater than or equal to zero. On the other hand, the above-mentioned L¹ comprises one selected from the group consisting of the following: OTf, X, RC(O)CHC(O)R, OAc, OEt, O-iPr, butyl, in which X comprises halogen elements. The above-mentioned L² comprises one selected from the group consisting of the following: H₂O, CH₃OH, EtOH, THF, CH₃CN,

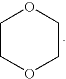

In this embodiment, the metal M of the mononuclear oxometallic complex comprises the following four groups: IVB, VB, VIB, actinide groups. The m and y depend on the classification of the metal M. For example, [1] as the metal M comprises an IVB group transition metal element and m=1, y=2 and the preferred metal M further comprises one selected from the group consisting of the following: titanium (Ti), zirconium (Zr), and hafnium (Hf); [2] as the metal M comprises a VB group transition metal element and m=1, y=2 or as m=1, y=3 and the preferred metal M further comprises vanadium (V) or niobium (Nb); [3] as the metal M comprises a VIB group transition metal element and m=1, y=4 or as m=2, y=3 and the preferred metal M further comprises molybdenum (Mo), tungsten (W), or chromium (Cr); [4] as the metal M comprises an actinide group transition metal element and m=2, y=2 and the preferred metal M further comprises uranium (U).

### Example 1

### Process of the Acyl Substitution-Based Polymerization

A two-necked, 50-mL flask with a stirring bar and is equipped with a Dean-Stark trap. The flask is then vacuum dried by flame and thereby is slowly cooled to room temperature, and is flushed with nitrogen gas. About 1 mL of water is placed inside the trap. 5 mmol of the first monomer with a plurality of carboxyl groups or a plurality of ester groups and 5 mmol of the second monomer with a plurality of protic nucleophilic groups are precisely measured. Then, 10 mL of nonpolar solvent, such as high boiling (cyclo)alkanes, ethers (anisole, dioxane, or DME), haloalkanes (e.g., chloroform or carbon tetrachloride (CCl₄), or arenes (e.g., benzene, toluene, ethylbenzene, or xylene) is added. The reaction content in the flask is stirred to become homogeneous while heated up to the refluxing temperature with removal of water. After having been refluxed for 30 minutes, the reaction mixture is then cooled to room temperature. Catalyst loading typically in 0.1-10 mol % is measured and placed in the reaction flask. The reaction flask is again heated up to the refluxing temperature. After the reaction is complete, the reaction flask is then cooled to room temperature and quenched by adding aqueous NaHCO₃ solution (25 mL). The resulting separated organic layer is dried by magnesium sulfate, filtered, and evaporated. The crude polymer can be provided with reasonably good purity. Pure polymer can be obtained by induced precipitation or by column chromatography.

Process with Complete Removal of Water-Soluble Catalyst:

A two-necked, 50-mL flask with a stirring bar is equipped with a Dean-Stark trap. One mmol of the first monomer with a plurality of carboxyl groups or a plurality of ester groups, 1 mmol of the second monomer with a plurality of protic nucleophilic groups, and catalyst with proper loading such as 0.5-10 mol %, are precisely measured. Then, 10 mL of anhydrous solvent mentioned above is added. The solution in the flask is then heated up to the refluxing temperature with removal of water. After the reaction is complete, the reaction flask is then cooled to room temperature and quenched by adding straight cold water (15 mL). At the time, the catalyst is dissolved in the water layer. Then, methylene chloride (CH₂Cl₂) is added to completely extract the polymer product to the organic layer (15 mL×3). The resulting separated organic layers are dried by magnesium sulfate, filtered, and evaporated to obtain crude polymer product. The crude polymer product is then dissolved in 5 mL of chloroform. Four mL of acetone is added to precipitate out the polymer and then 2 more mL of acetone is used to wash the solid. The polymer is then dried by vacuum for 15 minutes to obtain the final product.

Process with Catalyst Recovery:

A two-necked, 50-mL flask with a stirring bar is equipped with a Dean-Stark trap. One mmol of the first monomer with a plurality of carboxyl groups or a plurality of ester groups, 1 mmol of the second monomer with a plurality of protic nucleophilic groups, and catalyst with proper loading, such as 0.1-10 mol %, are precisely measured. Then, 10 mL of anhydrous nonpolar solvent mentioned above is added. The reaction content in the flask is then heated to the refluxing temperature with removal of water. After the reaction is complete, the reaction flask is then cooled to room temperature. Part of solvent is evaporated to concentrate the reaction solution. The crude polymer product is formed as a solid precipitate which can be settling separated directly. The collected solid is dissolved in 10 mL of chloroform. Four mL of acetone is added to precipitate out the polymer and then 2 more mL of acetone is used to wash the polymer. The polymer is then dried by vacuum for 15 minutes to obtain the final product. For catalyst recovery, the acetone layer is dried to obtain the recycled catalyst.

For example, the product is a polymer of adipic acid and diethylene glycol, which can be synthesized as shown in the following reaction equation and the data follows:

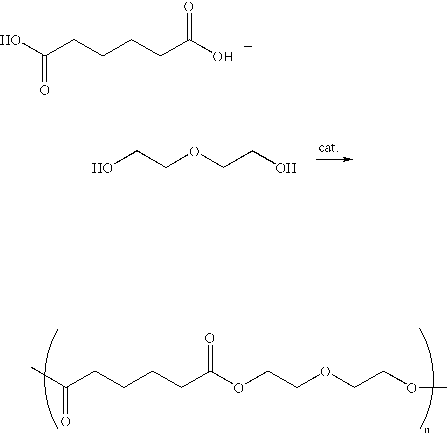

IR (CCl₄) 2951 (w), 1738 (s), 1454 (w), 1380 (w), 1262 (m), 1147 (m), 1070 (w); ¹H NMR (400 MHz, CDCl₃) δ 4.12-4.11 (bd, J=4.1, 4H), 3.59-3.58 (br m, 4H), 2.25-2.14 (br d, 4H), 1.60-1.54 (br d, 4H); ¹³C NMR (100 MHz, CDCl₃) δ 172.92, 68.75, 63.05, 33.52, 24.05; DP=>100, Mₙ=1.64×10⁴, M_{w}=2.24×10⁴.

### Example 2

The mononuclear oxometallic complex provided by the invention is used to catalyze the polymerization between the monomer having ester or carboxylic groups on both ends and diol/glycol to form polyester polymers. The reaction is similar to that in example 1.

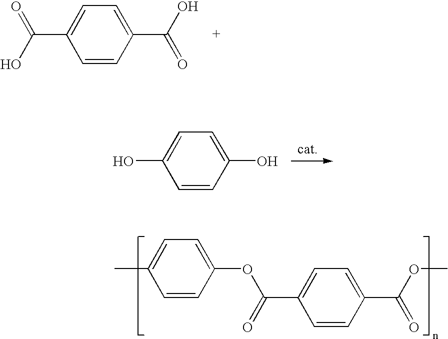

Polymer between Terephthalic Acid and 1,4-Benzenediol

¹H NMR (400 MHz, CDCl₃) δ 8.28 (s, 4H), 7.26 (s, 4H); ¹³C NMR (100 MHz, CDCl₃) δ 164.00, 149.92, 134.93, 130.34, 121.80

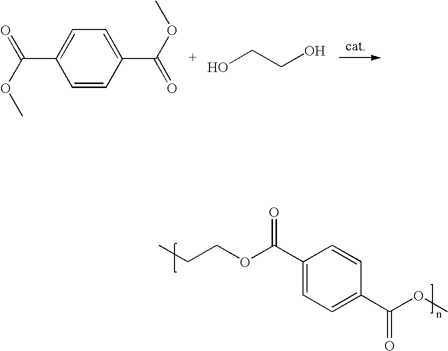

### Polyethyleneterephthalate (PET)

¹H NMR (400 MHz, CDCl₃) δ 8.07 (s, 4H), 4.68 (s, 4H); ¹³C NMR (100 MHz, CDCl₃) δ 166.0, 133.78, 129.60, 66.97

### Example 3

In the field of the engineered plastics, transparent resin with excellent mechanical property has been extensively applied in a variety of optical materials. For example, poly(methyl methacrylate) (PMMA) and polycarbonate (PC) are usually applied in compact discs, laser discs, transparent substrates, optical lenses, dash boards, car windshields and so forth. PMMA has advantages of high transparency and low optical anisotropy but it is apt to absorb water. Therefore, the PMMA product tends to deform and has moderate stability. On the other hand, PC has advantages of high transparency and good heat-resistance but it has moderate fluidity. Therefore, the PC product has obvious birefringence phenomenon. According to the above reasons, neither PMMA nor PC can satisfy the requirements of the optical materials in the current technology.

Particularly, during the development of flat panel displays, flexible substrate is the main demand in recent years. In addition to the needs of light, thin, short, and small characteristics, the polymer film needs to be rolled up, readily carried, unbreakable, easily molded into irregular shapes, and manufactured by using roll-to-roll continuous method to reduce production cost. For example, aromatic polyesters have high transparency, the characteristics of good water and gas resistance, dimensional stability while processed, good film-forming ability, high heat-resistance, acid-base and solvent-resistance so that aromatic polyesters are potential substrates to replace glass substrate for displays, such as TFT-LCD, OLED, and PLED to achieve the requirements of light, thin, short, and small characteristics. However, the polymer production process is somewhat complicated and costly due to multi-step synthesis. Alternatively, referring to the following reaction equation, the mononuclear oxometallic complexes provided by the invention can be used to catalyze the polymerization directly between the aromatic monomer (R is H or C₁-C₅ alkyl group.) bearing ester or carboxylic groups on both ends and aromatic diols to form aromatic polyesters so as to significantly reduce production cost. It is highly valuable in terms of ease industrial commercialization.

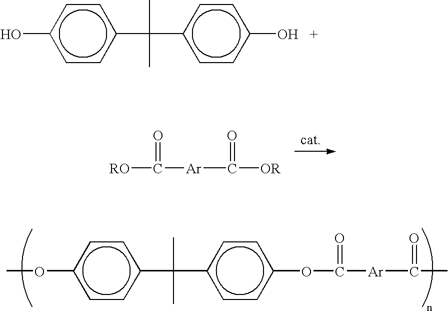

Polymer between Terephthalic Acid and 4,4′-isopropylidene diphenol (bis-phenol A)

¹H NMR (400 MHz, CDCl₃) δ 8.15 (s, 4H), 7.20 (d, 4H), 7.07 (d, 4H), 1.65 (s, 6H); ¹³C NMR (100 MHz, CDCl₃) δ 166.42, 153.36, 143.04, 137.71, 130.34, 127.89, 120.75, 41.57, 30.95

### Example 4

The mononuclear oxometallic complexes provided by the invention are used to catalyze the formation of aramid. Aramid comprises m-aramid and p-aramid according to chemical structure characteristics. Nomex and Kevlar (the products of DuPont Company, USA) whose structures are shown in the following, are typical examples for m-aramid and p-aramid, respectively. m-Aramid fiber has excellent fire-resistance and heat-resistance and thus is suitable for fire-resistant fabrics. p-Aramid fiber has high strength and is mainly applied in the field of bullet proof appliances.

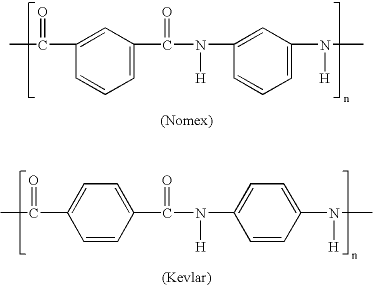

m-Aramid has excellent heat stability, flame-retardant, and insulation and has been extensively applied in high temperature-resistant materials. Global annual yield is about 20,000 tons and the price is about 20˜60 USD/kg according to classification. For example, Nomex is usually in a form of paper- and cardboard and can be cut out according to needs for different machine tools. Notably, the thickness of Nomex can be varied in accordance with different paper types. The thinnest one can be 0.05 mm. The thickness is so thin that Nomex is applied in various thin tool spaces and in various application fields. For example, in the case of a paper hot-pot, because the thickness is only 0.05 mm, the paper hot pot is heated evenly and quickly without kindling. Nomex has many more extraordinary characteristics. In the case of its heat stability, Nomex can be continuously operated under 220° C. high temperature environment for ten years without any physical or chemical degradation. Even when Nomex is exposed at 300° C. for a short period of time, it does not shrink, become brittle, soften, or melt. Because of the characteristics of Nomex, the lifetime of machine tools, especially for motors and generators can be extended so as to ensure safe operation.

Referring to the following reaction equation, the mononuclear oxometallic complexes provided by the invention are used to catalyze the reaction between phthalic acid or phthalate (R is H or C₁-C₅ alkyl group.) and phenylene diamine to form aramid polymer.

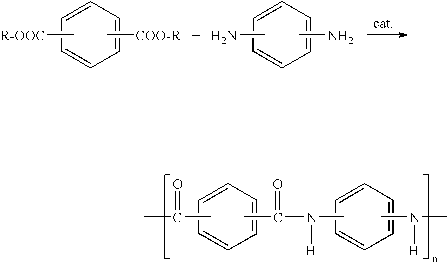

In the second embodiment of the invention, a method of nucleophilic acyl substitution-based polymerization catalyzed by a given mononuclear oxometallic complex is disclosed. At first, a monomer with at least one carboxyl group or ester group and at least one protic nucleophilic group is provided wherein the carbon number of the ester group is about 1-5 and the protic nucleophilic group comprises hydroxyl, amine, or thiol group. Mononuclear oxometallic complex is then used as catalyst to trigger the monomer to polymerize with each other. A preferred reaction equation is shown in the following. The monomer has one ester group or carboxyl group and a protic nucleophilic group (HA-R¹—COOR²; R² is H or C₁-C₅ alkyl group.) wherein A comprises O, S, or N. The mononuclear oxometallic complex M=OₘL¹_{y}L²_{z} with at least one M=O double bond catalyzes the monomer to polymerize with each other to form polymer.

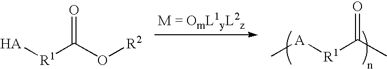

The m and y of the mononuclear oxometallic complex are integers of greater than or equal to 1 and z is an integer of greater than or equal to zero. On the other hand, the above-mentioned L¹ comprises one selected from the group consisting of the following: OTf, X, RC(O)CHC(O)R, OAc, OEt, O-iPr, butyl, in which X comprises halogen elements. The above-mentioned L² comprises one selected from the group consisting of the following: H₂O, CH₃OH, EtOH, THF, CH₃CN,

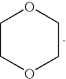

In this embodiment, the metal M of the mononuclear oxometallic complex comprises the following four groups: IVB, VB, VIB, actinide groups. The m and y depend on the classification of the metal M. For example, [1] as the metal M comprises an IVB group transition metal element and m=1, y=2 and the preferred metal M further comprises one selected from the group consisting of the following: titanium (Ti), zirconium (Zr), and hafnium (Hf); [2] as the metal M comprises a VB group transition metal element and m=1, y=2 or as m=1, y=3 and the preferred metal M further comprises vanadium (V) or niobium (Nb); [3] as the metal M comprises a VIB group transition metal element and m=1, y=4 or m=2, y=2 and the preferred metal M further comprises molybdenum (Mo), tungsten (W), or chromium (Cr); [4] as the metal M comprises an actinide group transition metal element and m=2, y=2 and the preferred metal M further comprises uranium (U).

### Example 5

The mononuclear oxometallic complexes provided by the invention are used to catalyze the formation of polylactide (PLA), polyglcolic acid (PGA), or other copolymers. Polylactide is the most representative commercial biochemical fiber materials exhibiting excellent potential in biomedical applications. Cargill Dow LLC (Cargill Inc. and Dow Chemical 50/50 shared company) is the most important manufacturer in producing polylactide raw materials and fibers. The starting raw material is from corns. The starch in corn is degraded to simple carbohydrates, and then digested into lactic acid by fermentation, which is carried on in a polymerization to obtain basic raw material oligo-LA for manufacturing final plastics. PLA can be utilized to produce various plastic products by molding injection. PLA-based plastics normally can be decomposed in about a month through biodegradation, meeting environmental protection trend. On the other hand, plastic bags made from petroleum chemicals take a few centuries for decomposition. The commercialized PLA-based products comprise mattresses, golf shirts, soft drink cups, MD packaging boxes and so forth. Furthermore, polylactide exhibits not only transparency, excellent forming characteristics, and high melting point but also shows impact resistance and flexibility. The toughness of polylactide is about the same level as PP (polypropylene). Because PLA has good bio-compatibility, it can be used as a suture for suturing wound and also can be applied in medicine releasing system or composite material implanted in human bodies, such as bone screw. Therefore, PLA is also called “biomedical absorptive polymer”.

Conventionally, the method to synthesize PLA is to heat and dehydrate lactic acid monomers and then to form oligomer intermediates by step growth. Subsequent continuous heating of the oligomer leads to white crystalline lactide. The temperature is then maintained at 175° C. resulting in critical melting state. Stannous chloride or stannous octanoate catalyst is added to catalyze the ring opening polymerization for 2˜6 hours to form PLA.

On the other hand, poly glycolic acid (PGA) is a simple linear polyester polymer with crystalline structure. Therefore, PGA has higher melting point and is difficult to be dissolved in organic solvents. By synthetic method, PGA was used to prepare surgical absorptive sutures in 1970s. The main function is to reduce mechanical property of sutures so as to be degraded after having been implanted in human bodies for 2˜4 weeks.

The physical and chemical properties of poly(glycolide co-lactide) (PLGA) do not have a linear relationship with the polymerization ratio of PLA and PGA. In the case of PLGA (50:50), its degrading rate is higher than those for PGA and PLA. Therefore, the selection of the polymerization ratio of PLA and PGA closely relates to the degree of crystallinity, solubility, water absorbability and degrading rate of the whole polymer. In medical applications, while PLGA is used clinically for a long period of experimental time, it is found that PLGA has excellent biocompatibility under physiological environment. Besides, the final product from the degradation of PLGA in human bodies is not poisonous to humans. Thus, PLGA degradable polymer is approved by various authorities in the world, such as U.S. Food and Drug Administration (FDA).

Various mononuclear oxometallic complexes provided by the invention can be used to catalyze lactic acid, glycolic acid, or a combination of the two to carry out (co)polymerization to form PLA, PGA, and PLGA.

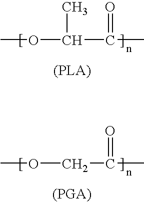

We have further invented the uses of various 5-substituted-2,2-dimethyl-1,3-dioxolan-4-ones as the monomer units for catalytic polymerization. By using benzyl amines, alcohols, di/triamine, or di/triols as the capping and initiating reagents and mononuclear oxometallic species as the catalysts, we can effect smooth poly-condensation leading to a wide variety of polylactate, poly-mandelate, and other derivatives. More importantly, random or block co-polymers can be prepared with judicious combination of two or more monomer classes. Meldrum acid may also be incorporated into the aforementioned polymerization technique.

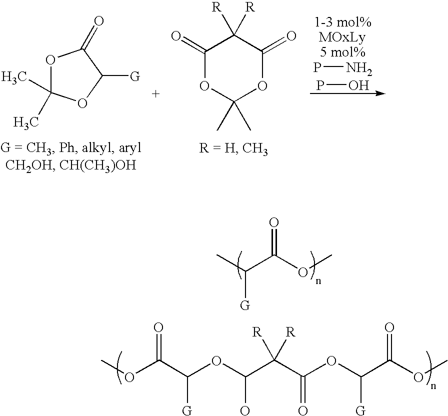

In addition, other monomers derived from acetonide-protected methyl glycerate, methyl oleoate, methyl 9-hydroxy-nonanoate, and dimethyl 2-hydroxyphosphonates may be incorporated for the polymerizations mentioned above.

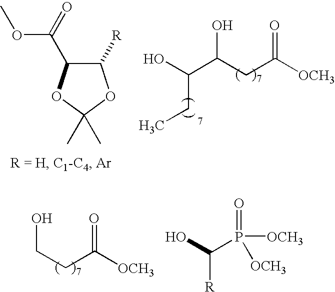

Furthermore, 1,3-dioxolane-2,4-diones and 1,3-oxazoline-2,4-diones derived from the corresponding 2-hydroxyacids and 2-amino acids can be utilized to replace the previous 2,2-dimethyl-1,3-dioxolan-4-ones for the same polymerizations. Homopolymers and copolymers made from 1,3 dioxolan-4-one monomers have been described in U.S. Pat. No. 5,424,136. However, the catalysts used in U.S. Pat. No. 5,424,136 were Sn(II), Sn(IV), Al-related species, which are different from those in this invention. The polymers are useful in making a variety of products, including medical devices such as bioabsorbable medical implants.

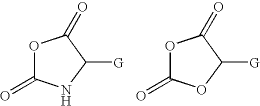

A given 5-substituted-2,2-dimethyl-1,3-dioxolan-4-one, 1,3-dioxolan-2,4-dione or a combination of several monomer units (10 mmol) was dissolved in xylene (50 mL). A solution of mononuclear oxometallic species (0.1-10 mol %) and benzyl amine, alcohol, di/triamines or di/triols (5 mol %) in xylene was added. The whole mixture was heated to 120° C. for 24 to 36 hours. The reaction mixture was cooled to ambient temperature and cold water (20 mL) was added. The organic layer was separated, dried, and concentrated under reduced pressure to give white viscous powder. Gel permeation chromatographic analysis was carried out for the product in THF. Only an aliquot of the clear solution was injected into the GPC column. The analysis results indicate that the soluble component has a weighted molecular weight of 7963 with degree of polydispersity equal to 1.28 when monoamine or monoalcohol is employed. On the other hand, the complete solid dissolved in haloalkanes show a weighted molecular weight of greater than 13,000.

Additionally, similar catalytic polymerization can be performed as the above-mentioned.

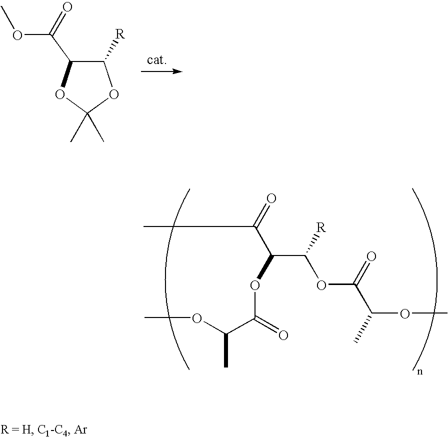

### Example 6

Among various aliphatic polyesters, poly(caprolactone) (PCL) has broad applications and conventionally is manufactured by the ring opening polymerization of ε-caprolactone. PCL is a thermoplastic crystalline polyester with a melting point of 80° C. and decomposed at 250° C. The rigidity of PCL is similar to that of an intermediate-density polyethylene. PCL has a waxy feeling and good compatibility with many polymers. At present, Union Carbide Corp. has carried out batch-production for PCL with a product name of TONE, applied in surgical appliances, adhesives, and pigment dispersing agents. If natural mineral substances, such as talc powders and calcium carbonates, are added in PCL, it is more elastic and cheaper than the pure PCL. Biodegradable plastics can be manufactured by compounding PCL and PHB.

The various mononuclear oxometallic complexes provided by the invention can be used to catalyze 6-hydroxycaproic acid to carry out a nucleophilic acyl substitution polymerization with each other as well as to catalyze the ring opening polymerization of ε-caprolactone to form PCL.

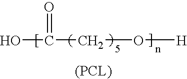

### Example 7

The mononuclear oxometallic complexes provided by the invention can be used to catalyze 9,10-dihydroxylated oleic acid or oleate, such as methyl and ethyl oleate, to form polyesters. Referring to the following reaction equation, an oxidation reaction (abbreviated as “ox.” in the equation) is carried out to oxidize the 9,10-double bond on the oleic acid or oleate to form two hydroxyl groups. Next, the mononuclear oxometallic complexes provided by the invention catalyze carboxyl groups or ester groups and newly formed hydroxyl groups to carry out a nucleophilic acyl substitution polymerization to form a new dendritic polyester. Because oxidized oleic acid or oleate has three reactive functional groups, the resulting polyester has three-dimensional (3D) crosslinking structure and thus has good mechanical property and higher glass transition temperature (Tg) than polylactide. Therefore, this new polyester has excellent potential to replace polylactide and can also be applied in biodegradable heat-resistant plastics.

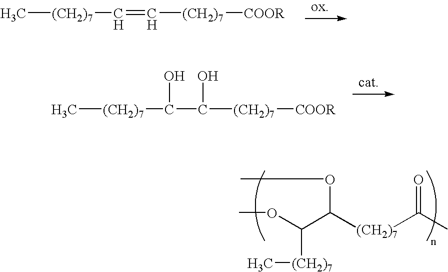

Furthermore, similar catalytic polymerization can be performed as the above-mentioned.

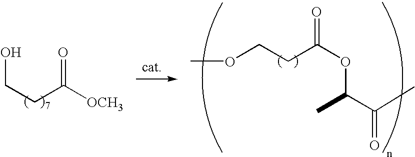

### Example 8

Phosphonate polymers have been produced from the condensation reaction of a phosphonic acid group with an alcohol or with an amine having a reactive hydrogen. A polymeric product can be produced by reacting a polyphosphonate or an anhydride of a polyphosphonate with a polyhydric alcohol as is described in U.S. Pat. No. 3,395,113 and U.S. Pat. No. 3,470,112, or by reacting a hydroxyphosphonate such as ethane-1-hydroxy-1,1-diphosphonic acid, as is described in U.S. Pat. No. 3,621,081, in each case forming a polyester. A polymeric product can also be formed by reacting a polyphosphonate anhydride with a polyamine as is described in U.S. Pat. No. 3,645,919. Formation of these polymeric products requires the presence of a reactive hydrogen on either an alcohol or an amine group.

Various mononuclear oxometallic complexes provided by the invention can be used to catalyze the condensation reaction of a phosphonic acid group with an alcohol to carry out polymerization.

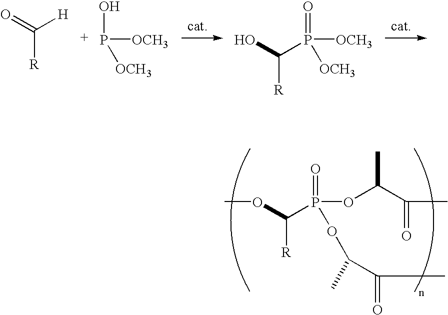

In the above-described embodiments according to the invention, a nucleophilic acyl substitution-based polymerization is catalyzed by mononuclear oxometallic complexes. The polymerization method can be operated in a simple manner under mild reaction conditions. Besides, in some polymer systems, polymeric products are formed as precipitating solids to be settling-separated directly from the solvents. In addition, the mononuclear oxometallic complexes provided by the present invention have the characteristics of long-term activity, and high water and oxygen compatibilities so that the polymerizations can proceed in the above-mentioned polymer systems as long as the designated monomers are continuously provided. Thus, the production cost is significantly reduced. Furthermore, the mononuclear oxometallic complexes can be recycled after the nucleophilic acyl substitution reaction and the recycled mononuclear oxometallic complex still maintains excellent catalytic activity. Therefore, the method according to the present invention has not only the economic advantages for industrial applications but also environmental friendliness.

To sum up, the present invention discloses a method of nucleophilic acyl substitution-based polymerization by mononuclear oxometallic complexes. At first, the first monomer with a plurality of carboxyl groups or ester groups and the second monomer with a plurality of protic nucleophilic groups are provided. The protic nucleophilic groups comprise hydroxyl, amine, or thiol group. Next, the polymerization between the first monomer and the second monomer catalyzed by mononuclear oxometallic complex is carried out to form polymers. On the other hand, the present invention also discloses another method of nucleophilic acyl substitution-based polymerization catalyzed by mononuclear oxometallic complexes. At first, a monomer with at least one carboxyl group or at least one ester (phosphonates) group and at least one (masked) protic nucleophilic group is provided. Next, the polymerization of the monomer with each other catalyzed by mononuclear oxometallic complex is carried out to form polymers.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method of nucleophilic acyl substitution-based polymerization catalyzed by mononuclear oxometallic complex, comprising:
providing the first monomer with a plurality of carboxyl groups or ester groups and a second monomer with a plurality of protic nucleophilic groups wherein said protic nucleophilic groups comprise hydroxyl, amine, or thiol group; and,
catalyzing a polymerization between said first monomer and said second monomer by mononuclear oxometallic complexes wherein said mononuclear oxometallic complexes have the general formula M=OₘL¹_{y}L²_{z} with at least one M=O double bond in which m and y are integers of greater than or equal to 1 and z is an integer of greater than or equal to zero, and said metal M of said mononuclear oxometallic complexes comprise one selected from a group consisting of the following: IVB, VB, VIB and actinide groups.

2. The method according to claim 1, wherein said first monomer has a plurality of ester groups and the carbon number of said ester groups is about from 1 to 5.

3. The method according to claim 1, wherein said L¹ comprises one selected from the group consisting of the following: OTf, X, RC(O)CHC(O)R, OAc, OEt, O-iPr, butyl in which X comprises halogen elements.

4. The method according to claim 1, wherein said L² comprises one selected from the group consisting of the following: H₂O, CH₃OH, EtOH, THF, CH₃CN,

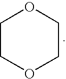

5. The method according to claim 1, wherein y=2 as said metal M comprises an IVB group transition metal element and m=1.

6. The method according to claim 5, wherein said metal M further comprises one selected from the group consisting of the following: titanium (Ti), zirconium (Zr), and hafnium (Hf).

7. The method according to claim 1, wherein y=2, as said metal M comprises a VB group transition metal and m=1.

8. The method according to claim 7, wherein said metal M further comprises vanadium (V) or niobium (Nb)

9. The method according to claim 1, wherein y=3 as said metal M comprises a VB group transition metal and m=1.

10. The method according to claim 9, wherein said metal M further comprises vanadium (V) or niobium (Nb).

11. The method according to claim 1, wherein y=4 as said metal M comprises a VI B group transition metal and m=1.

12. The method according to claim 11, wherein said metal M further comprises molybdenum (Mo), tungsten (W), or chromium (Cr).

13. The method according to claim 1, wherein y=2 as said metal M comprises a VI B group transition metal and m=2.

14. The method according to claim 13, wherein said metal M further comprises molybdenum (Mo), tungsten (W), or chromium (Cr).

15. The method according to claim 1, wherein y=2 as said metal M comprises an actinide group transition metal and m=2.

16. The method according to claim 15, wherein said metal M further comprises uranium (U).

17. A method of nucleophilic acyl substitution-based polymerization catalyzed by mononuclear oxometallic complexes:
providing a monomer with at least one carboxyl group or ester (phosphonates) group and at least one (masked) protic nucleophilic group wherein said protic nucleophilic group comprises hydroxyl, amine, or thiol group; and,
catalyzing said monomer to polymerize with each other by mononuclear oxometallic complexes wherein said mononuclear oxometallic complexes have the general formula M=OₘL¹_{y}L²_{z} with at least one M=O double bond in which m and y are integers of greater than or equal to 1 and z is an integer of greater than or equal to zero, and said metal M of said mononuclear oxometallic complexes comprise one selected from a group consisting of the following: IVB, VB, VIB and actinide groups.

18. The method according to claim 17, wherein the carbon number of said ester group is about from 1 to 5.

19. The method according to claim 17, wherein said L¹ comprises one selected from the group consisting of the following: OTf, X, RC(O)CHC(O)R, OAc, OEt, O-iPr, butyl in which X comprises halogen elements.

20. The method according to claim 17, wherein said L² comprises one selected from the group consisting of the following: H₂O, CH₃OH, EtOH, THF, CH₃CN,

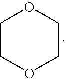

21. The method according to claim 17, wherein y=2 as said metal M comprises an IVB group transition metal element and m=1.

22. The method according to claim 21, wherein said metal M further comprises one selected from the group consisting of the following: titanium (Ti), zirconium (Zr), and hafnium (Hf).

23. The method according to claim 17, wherein y=2 as said metal M comprises a VB group transition metal and m=1.

24. The method according to claim 23, wherein said metal M further comprises vanadium (V) or niobium (Nb).

25. The method according to claim 17, wherein y=3 as said metal M comprises a VB group transition metal and m=1.

26. The method according to claim 25, wherein said metal M further comprises vanadium (V) or niobium (Nb)

27. The method according to claim 17, wherein y=4 as said metal M comprises a VIB group transition metal and m=1.

28. The method according to claim 27, wherein said metal M further comprises molybdenum (Mo), tungsten (W), or chromium (Cr).

29. The method according to claim 17, wherein y=2 as said metal M comprises a VI B group transition metal and m=2.

30. The method according to claim 29, wherein said metal M further comprises molybdenum (Mo), tungsten (W), or chromium (Cr).

31. The method according to claim 17, wherein y=2 as said metal M comprises an actinide group transition metal and m=2.

32. The method according to claim 31, wherein said metal M further comprises uranium (U).
